(19) United States
(12) Patent Application Publication
(10) Pub. No.: US 2006/0060035 A1
(43) Pub. Date: Mar. 23, 2006

(54) Fast monkey wrench

(76) Inventor: Changquan Chen, Shanghai (CN)

Correspondence Address: Min (Amy) S. Xu, Esq.;DORSEY & WHITNEY LLP, Intellectual Property Department, 50 South Sixth Street, Suite 1500, Minneapolis, MN, 55402-1498, US

(21) Appl. No.: 10/987,993

(22) Filed: Nov. 12, 2004

(30) Foreign Application Priority Data
Sep. 23, 2004 (CN) 200420090400.8

(51) Int. Cl. B25B 13/16

(52) U.S. Cl. 81/165; 81/166; 81/170

(57) ABSTRACT

The present invention discloses a kind of fast monkey wrench. It includes a wrench body, a wrench mouth, a worm, a mounting groove provided on the handle body of the wrench body, a guiding shaft having a spiral groove mounted in the mounting groove, and a push button mounted on the handle body. The push button is matched with the spiral groove of the guiding shaft in an embedded manner. A pair of meshed bevel gears are mounted between one end of the guiding groove and the worm. A large screw pitch worm is adopted as the worm. The good effects of the present invention are: new and unique structure, nimbleness and convenience in use, safety and reliability, fast operations.

### CROSS-REFERENCE TO RELATED APPLICATION(S)

This application claims priority to Chinese Patent Application No. 200420090400.8, filed on Sep. 23, 2004, the contents of which are incorporated herein by reference in its entirety.

### TECHNICAL FIELD

The present invention relates to a machinery tool. It is a manually operated tool, in particular, it relates to a kind of monkey wrenches or spanners.

### BACKGROUND ART

The monkey wrench is a conventional manually operated tool in common use. It is well received by users because it is easy for use and has good adaptability. Anybody can catch sight of it in all trades and professions as well as everyday life. However, the currently available monkey wrench has some drawbacks, especially, the wrench mouth suffers slow adjustment and it is not convenient for use in dark circumstances. Although some so-called “fast monkey wrenches” have come out in the market, their structures are not perfect enough. For example, they still adopt a worm having a conventional screw pitch, which will result in longer movement of the push button and inconvenient adjustment. Another example adopts a circular shaped push button which is not convenient for hand push. In addition, the cone gears mounted between one end of a guiding shaft and the worm are difficult in machining, their transmission is not reliable and they are liable to damage.

### SUMMARY OF THE INVENTION

The present invention aims to provide a kind of fast monkey wrench or spanner, which is agile and convenient in use, safe and reliable, and the operation of which is fast.

The technical solution of the present invention is as follows. The fast monkey wrench includes: a wrench body; a wrench mouth; a worm; a mounting groove provided in the handle body of the wrench body; a guiding shaft having a spiral groove mounted in the mounting groove; and a push button mounted on the handle body. The push button is matched with the spiral groove of the guiding shaft in an embedded manner. A pair of bevel gears are mounted between one end of the guiding shaft and the worm. A large screw pitch worm is adopted as the worm.

In the present invention, the screw pitch of the worm is 4˜10 mm, the modulus of the bevel gears is 0.5˜1.5. A hand protection layer is fitted onto the handle body. The push button has a shape of long waist, and slant curved surfaces for hand push are respectively formed at the front end and rear end of the push button. A single head worm is adopted as the worm.

The good effects of the present invention are: new and unique structure, nimbleness and convenience in use, safety and reliability fast operation, comfortableness when held in hands. It is especially suitable for being used as repairing tool for armament equipment and warfare equipment and suitable for being sued in situations where fast and accurate dismounting of nuts and bolts is required.

### DESCRIPTION OF THE DRAWINGS

The present invention will be further described with reference to the following embodiment shown in the accompanying drawing.

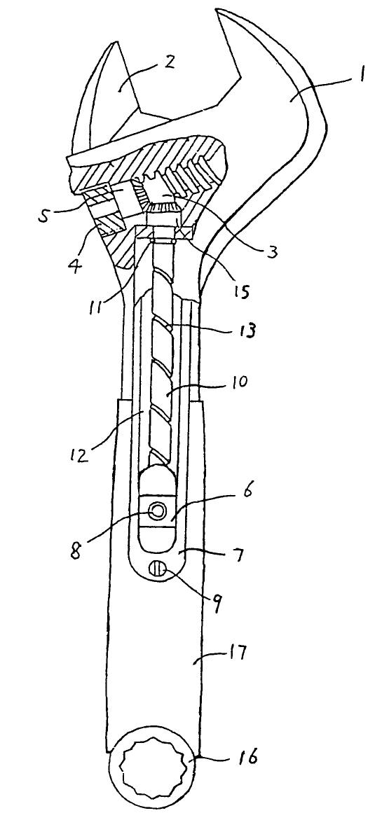

In the accompanying drawing, FIG. 1 shows a schematic view of the structure of the fast monkey wrench of the present invention.

### PREFERABLE MODE OF CARRYING OUT THE INVENTION

FIG. 1 shows one embodiment of the present utility model. In this embodiment, an 8″ wrench is shown. The wrench includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 6 mm, or other proper values between 4˜10 mm. The modulus of the bevel gears 5, 15 is 1, or other proper values between 0.5˜1.5. A hand protection layer 17 is fitted onto the handle body 1 (The layer can be made of elastic PP plastic material). The push button 6 has a shape of long waist, or other similar shapes, such as ellipse shape, etc. Slant curved surfaces or curved surfaces similar to the slant surfaces for hand push are respectively formed at the front and rear ends of the push button (Ripple lines can be made on the slant surfaces to increase the friction force). A plum blossom shaped spanner 16 (or other similar holes) is disposed at the distal end of the handle of the wrench body 1. FIG. 1 also shows a cap 4, a cover plate 7, a pin 8, a rivet 9, a wire circlip 11, etc.

The operation principle of the above-mentioned embodiment is as follows. When the push button 6 is pushed by hand, the guiding shaft 10 is forced to make rotation motion because of the sliding push transmission movement of the push button 6 with respect to the spiral groove 13 of the guiding shaft 10 in the mounting groove 12 of the wrench handle body in an embedded manner, and the bevel gear 15 mounted on the top end of the guiding shaft 10 mounted in the mounting groove 12 thus follows the guiding shaft 10 to rotate, and the bevel gear 15 in turn drives the meshed bevel gear 5 to rotate, The bevel gear 5 drives worm 3 to rotate and the worm 3 in turn drives the wrench mouth 2 to make a translational movement. Because the screw pitch of the worm is large, the speed of the translational movement of the wrench mouth 2 is much rapider than the similar conventional fast monkey wrench. Moreover, the length of the guiding shaft 10 is greatly reduced, which makes the distance moved by hand push or by driving the push button 6 is significantly reduced, resulting in the length of the wrench handle being further shortened. Thereby, the aim of fast opening and closing of the wrench mouth is really achieved. The plum blossom shaped spanner 16 at the end of the handle of the wrench body 1 can be used as a tool or a hole for hanging or suspending.

The present invention can also adopt another embodiment, in which it can be a 10″ wrench. It includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 7 mm. The modulus of the bevel gears 5, 15 is 1.2. A hand protection layer 17 is fitted onto the handle body 1. The push button 6 has a shape of long waist, or similar shapes, such as ellipse shape, etc. Slant curved surfaces for hand push are respectively formed at the front and rear ends of the push button. A round hole is disposed at the distal end of the handle of the wrench body 1. The present invention may adopt a third embodiment, in which it can be a 12″ wrench. It includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 8 mm. The modulus of the bevel gears 5, 15 is 1.4. A hand protection layer 17 is fitted onto the handle body 1. The push button 6 has a shape of long waist, or similar shapes, such as ellipse shape, etc. Slant curved surfaces for hand push are respectively formed at the front and rear ends of the push button. A plum blossom shaped spanner 16 is disposed at the distal end of the handle body of the wrench body 1.

The present invention may adopt a fourth embodiment, in which it can be a 16″ wrench. It includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 10 mm. The modulus of the bevel gears 5, 15 is 1.5. A hand protection layer 17 is fitted onto the handle body 1. The push button 6 has a shape of long waist, or similar shapes, such as ellipse shape, etc. Slant curved surfaces for hand push are respectively formed at the front and rear ends of the push button. A round hole is disposed at the distal end of the handle of the wrench body 1.

The present invention may adopt a fifth embodiment, in which it can be a 6″ wrench. It includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 5 mm. The modulus of the bevel gears 5, 15 is 0.8. A hand protection layer 17 is fitted onto the handle body 1. The push button 6 has a shape of long waist, or similar shapes, such as ellipse shape, etc. Slant curved surfaces for hand push are respectively formed at the front and rear ends of the push button. A plum blossom shaped spanner 16 is disposed at the distal end of the handle body of the wrench body 1.

The present invention may adopt a sixth embodiment, in which it can be a 4″ wrench. It includes a wrench body 1, a wrench mouth 2, a worm 3, a mounting groove 12 provided on the handle body of the wrench body 1, a guiding shaft 10 having a spiral groove 13 mounted in the mounting groove 12, and a push button 6 mounted on the handle body 1. The push button 6 is matched with the spiral groove 13 of the guiding shaft 10 in an embedded manner. A pair of bevel gears 5, 15 are mounted between one end of the guiding shaft 10 and the worm 3. A large pitch single head worm is adopted as the worm 3. The screw pitch of the worm 3 is 4 mm. The modulus of the bevel gears 5, 15 is 0.5. A hand protection layer 17 is fitted onto the handle body 1. The push button 6 has a shape of long waist, or similar shapes, such as ellipse shape, etc. Slant curved surfaces for hand push are respectively formed at the front and rear ends of the push button. A round hole is disposed at the distal end of the handle of the wrench body 1.

1. A fast monkey includes: a wrench body; a wrench mouth; a worm; a mounting groove provided on a handle body of said wrench body; a guiding shaft having a spiral groove mounted in said mounting groove; and a push button mounted on said handle body, said push button is matched with said spiral groove of said guiding shaft in an embedded manner, characterized in that a pair of meshed bevel gears are mounted between one end of said guiding shaft and said worm, and a large screw pitch worm is adopted as said worm.

2. The fast monkey wrench according to claim 1, characterized in that the screw pitch of said worm is 4˜10 mm.

3. The fast monkey wrench according to claim 1, characterized in that the modulus of said bevel gears is 0.5˜1.5.

4. The fast monkey wrench according to claim 1, characterized in that a hand protection layer is fitted onto said handle body.

5. The fast monkey wrench according to claim 1, characterized in that said push button has a shape of long waist, slant curved surfaces for hand push are respectively formed at the front and read ends of said push button.

6. The fast monkey wrench according to claim 1, characterized in that a single head worm is adopted as said worm.

7. The fast monkey wrench according to claim 2, characterized in that the modulus of said bevel gears is 0.5˜1.5.

8. The fast monkey wrench according to claim 2, characterized in that a hand protection layer is fitted onto said handle body.

9. The fast monkey wrench according to claim 2, characterized in that said push button has a shape of long waist, slant curved surfaces for hand push are respectively formed at the front and read ends of said push button.

10. The fast monkey wrench according to claim 2, characterized in that a single head worm is adopted as said worm.
